(19) United States
(12) Patent Application Publication
(10) Pub. No.: US 2009/0089871 A1
(43) Pub. Date: Apr. 2, 2009

(54) Methods and apparatus for digital data processor instantiation

(75) Inventors: Kevin J. Murphy, JR., Marlborough, MA (US); John Amaral, Boxborough, MA (US); Don Adams, Randolph, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: NETWORK ENGINES, INC., Canton, MA (US)

(21) Appl. No.: 11/481,089

(22) Filed: Jul. 5, 2006

Related U.S. Application Data
(63) Continuation-in-part of application No. 11/368,359, filed on Mar. 3, 2006.
(60) Provisional application No. 60/659,351, filed on Mar. 7, 2005.

(51) Int. Cl. G06F 17/00

(52) U.S. Cl. 726/11

(57) ABSTRACT

The invention provides, in one aspect, a digital data processing device includes a firewall device and a computer, both housed within the same enclosure and sharing a common path to the Internet (or other external network), yet, not sharing the same substantive processing logic. Thus, by way of example, the firewall device does not the computer's central processing unit (CPU) to execute firewall logic. The digital data processing device can be arranged to limit connectivity and/or functionality of the computer and/or firewall device, e.g., absent authentication. Thus, for example, the computer and firewall can be coupled to the common path—e.g., a modem, network interface card or other communications port supporting access via wired (e.g., wired ethernet and coaxial), wireless (e.g., satellite, telephony, 802.11x), and/or optical (e.g., fiber) means—such that that access by the computer to the Internet (or other external network) is mediated by the firewall device.

### BACKGROUND OF THE INVENTION

This application is a continuation-in-part of U.S. patent application Ser. No. 11/368,359, entitled “Methods and Apparatus for Installation/Reinstallation of Executable Disk Images On Digital Data Processors,” filed Mar. 3, 2006, which claims the benefit of U.S. Provisional Patent Application Ser. No. 60/659,351, entitled “Methods and Apparatus for Installation/Reinstallation of Executable Disk Images On Digital Data Processors,” filed Mar. 7, 2005, the teachings of both of which are incorporated herein by reference.

The invention pertains to digital data processing and, more particularly, to methods and apparatus for controlling the connectivity and functionality of digital data processing equipment. The invention has application, by way of example, in the distribution and installation of personal computers (PC) and servers.

As the computer industry matures, computer hardware—particularly personal computers (PCs) and servers—has largely become commoditized. The rapid advances in proprietary operating system and application development that characterized the 1990s have slowed as the user community's absorbs of now-aging but, still, feature-laden operating systems and applications. Coupled with the recession of the early 2000s and the emergence of platform-neutral open source software, demand for super-fast hardware is now relegated to market niches.

Enterprises looking to decrease information technology investment now increasingly think of buying generic “boxes,” rather then brand-specific “IBMs,” “Dells” and “Gateways” of years past. These and other hardware manufacturers have responded by shifting an increasing percentage of manufacture and assembly off-shore, with R&D emphasis on manufacturing process, rather, than equipment.

Profit margins remain high in software. Though the emergence of open source threatens this, the software industry has far too much to lose—and the standard open source licenses far too flexible—to make the threat of lasting significance. And, while off-shoring of software production is increasing in prevalence, it is not likely to have the long-term profit-deadening effect as seen in hardware.

The challenge to software and hardware makers alike remains to meet and, indeed, beat customer expectations for price and performance, while meeting shareholder demands for growth and profit.

An object of this invention is to provide improved methods, apparatus and systems for digital data processing.

A further object of the invention is to provide such methods, apparatus and systems as pave the way for meeting, if not beating, the aforementioned customer and shareholder demands alike.

A more particular object of the invention is to provide such methods, apparatus and systems as facilitate controlling the connectivity and/or functionality of digital data processing equipment, software, data files, and the like.

A related object of the invention is to provide such methods, apparatus and systems as facilitate the distribution and/or installation of digital data processing equipment, software, data files, and the like.

A further object of the invention is to provide such methods, apparatus and systems as can be implemented at reasonable cost on existing and future platforms

### SUMMARY OF THE INVENTION

The foregoing are among the objects attained by the invention which provides, in some aspects, improved digital data processors and methods of operation thereof which rely on integral firewalls and token-based authentication to secure computers from network access and other I/O and, thereby, insure that only authorized equipment can be operated and only authorized software, patch files, configuration files, data and/or other files (collectively, “software”) can be installed on them. Potential uses of the invention include, by way of non-limiting example, rendering servers and/or personal computers non-functional—and, hence, valueless—until authorized connectivity is established and/or authorized software is installed on them.

More generally, according to one aspect of the invention, a digital data processing device includes a firewall device and a computer, both housed within the same enclosure and sharing a common path to the Internet (or other external network), yet, not sharing the same substantive processing logic. Thus, by way of example, the firewall device does not share or use the computer's central processing unit (CPU) to execute firewall logic.

The computer, according to related aspects of the invention, comprises a CPU and static storage, e.g., a disk drive, static RAM, or the like. It may be configured as a general-purpose computer, a special-purpose computer, personal digital assistant, MP3 player, game player, or other digital data processing device. The firewall device may also comprise a CPU and storage, albeit separate and apart from those of the computer. Alternatively, or in addition, the firewall may be, by way of example, implemented in specialized packet-processing or other circuitry.

According to related aspects of the invention, the storage maintained by each of the firewall device and the computer is dedicated. Put another way, those apparatus do not share each other's respective disks, static RAM or other storage. Likewise, the firewall and computer can each have their own respective power supply.

Further aspects of the invention provide a digital data processing device as described above that is arranged to limit connectivity and/or functionality of the computer and/or firewall device, e.g., absent authentication. Thus, for example, the computer and firewall can be coupled to the common path—e.g., via a modem, network interface card or other communications port supporting access via wired (e.g., wired ethernet and coaxial), wireless (e.g., satellite, telephony, 802.11x), and/or optical (e.g., fiber) means—such that that access by the computer to the Internet (or other external network) is mediated by the firewall device.

By way of further example, the computer can include a security module that limits (or prevents) operation, modification and/or connectivity of the computer, e.g., absent physical, electrical, electromagnetic, magnetic, or other coupling of a token (such as a key fob, smart card, credit card, or the like) and/or external authorization, e.g., from a vendor or third-party, via the Internet (or external network). The firewall device, too, can include such a security module, for example, that limits its operation, modification and/or connectivity, again, for example, absent a token and/or external authorization.

In other related aspects, the invention provides a digital data processing device as described above in which the computer and firewall device communicate with one another over the path and not, by way of example, via other media or by other means. Such communications can be, for example, via an ethernet protocol.

Other aspects of the invention provide a digital data processing device as described above in which the computer is prevented from booting, loading at least selected software files, configuration files, data files, patch and/or other files, executing or using at least selected such files, accessing to at least selected peripherals, and/or processing at least selected data, in the absence of a token and/or external authorization. Likewise, the firewall device can be prevented from operating, updating, accessing and/or permitting the computer to access the Internet (or other external network) and/or selected addresses thereon. The firewall can, instead or in addition, be prevented from accessing (or permitting access on) at least selected ports, of at least selected packet types, by at least selected applications.

Still other aspects of the invention provide a digital data processing device as described above in which the computer executes a plurality of operating system instances within a virtual machine environment. Each operating system instance can include an operating system and one or more applications programs. The instances utilize independent memory spaces, registries, stacks, environmental variables, and so forth. Hence, faults in one instance do not affect the other. Nor, for example, need maintenance of one instance depend on maintenance of another.

Related aspects of the invention provide a digital data processing device as described above in which the one or more of the operating system instances are pre-configured (e.g., “at the factory”), while one or more of the other instances can be configured ad hoc (e.g., by the purchaser). The aforementioned security module can monitor execution of, for example, the ad hoc instances to insure that operating system and other software files, configuration files, data files, patch and/or other files executing on (or used by) them has been authorized.

The invention provides, in still other aspects, a digital data processing system comprising a digital data processing device as described above that is coupled to one or more additional computers, e.g., on a local area network (LAN) or other network segment. The digital data processing device can be configured as a mail server, file system server, proxy server, or otherwise, utilizing either a pre-configured or ad hoc operating system instance to support such functionality. The digital data processing device can also serve as a store-and-forward site for software files, configuration files, data files, patch and/or other files executed or used by those additional computers.

Still further aspects of the invention provide methods of use of a digital data processing device, e.g., of the type described above. One such method includes shipping or otherwise providing such a digital data processing device to remote or other site with (i) the firewall device “locked down” so as to provide restricted connectivity, if any, to the Internet (or other external network), and (ii) a limited set of pre-installed software files, patch files, configuration files, rules files, data and/or other files, if any. The method further includes coupling a token, e.g., of the type mentioned above, to the digital data processing device (e.g., once located at the remote or other site) and, as a result thereof, establishing connectivity over the Internet (or other external network) with an authentication system. That system can be a central IT administrator's site, a vendor site, a third-party authentication site, and so forth—or a combination of such sites.

That authentication system, according to further aspects of the invention, authenticates the digital data processing device, the computer, any software files, patch files, configuration files, rules files, data and/or other files, thereon, the firewall device, the token, the operator, and/or the actual or apparent location of the digital data processing device in the real world, digital world or otherwise, e.g., based on on-board GPS, IP address routing, user input, and so forth.

Following authentication, the authentication system can signal the security module to remove or loosen restrictions on operating and/or updating the computer, including, for example, restrictions on booting the computer, loading or executing software files, configuration files, patch files, rules files, data and/or other files, accessing peripherals, and/or processing data. Such signaling can likewise result in removing or loosening restrictions on operating and/or updating the firewall, including, for example, restrictions on accessing the Internet (or other external network), addresses thereon, via ports, using selected packet types and/or by applications. Alternatively, or in addition, the authentication system can signal the security module and/or the token to effect affirmative steps, such as, booting the computer and decrypting, installing and/or executing software files, configuration files, patch files, rules files, data and/or other files thereon, and so forth.

Related aspects of the invention provide a method as described above in which the authentication steps described above include verifying payment and/or credit history, e.g., of the recipient of the digital data processing system. This can include, for example, verifying that the digital data processing system, software files, configuration files, data files, rules files, patch and/or other files and/or other services have (or can be) paid for.

Further related aspects of the invention provide methods as described above in which the security module responds to signaling from the authentication system by downloading and/or decrypting, e.g., from disk drive in the computer, software files, patch files, configuration files, rules files, data files, other files, and/or disk images for installation. This can include selecting from among multiple options loaded by the manufacturer, e.g., depending on payment history, credit history, etc.

Still further aspects of the invention provide digital data processors and/or digital data processing systems operating in accord with the foregoing methods.

These and other aspects of the invention are evident in the drawings and in the text that follows.

### BRIEF DESCRIPTION OF THE DRAWINGS

A more complete understanding of the invention may be attained by reference to the drawings, in which:

FIG. 1 depicts a digital data processing device and system according to one practice of the invention;

FIG. 2 depicts an enclosure of the type in which a digital data processing device of the invention is contained;

FIG. 3 depicts an installation of software on the digital data processing device of FIG. 1; and

FIGS. 4 and 5 depict methods of authenticating the digital data processing device of FIG. 1 for initial installation and update.

### DETAILED DESCRIPTION OF THE ILLUSTRATED EMBODIMENT

Architecture

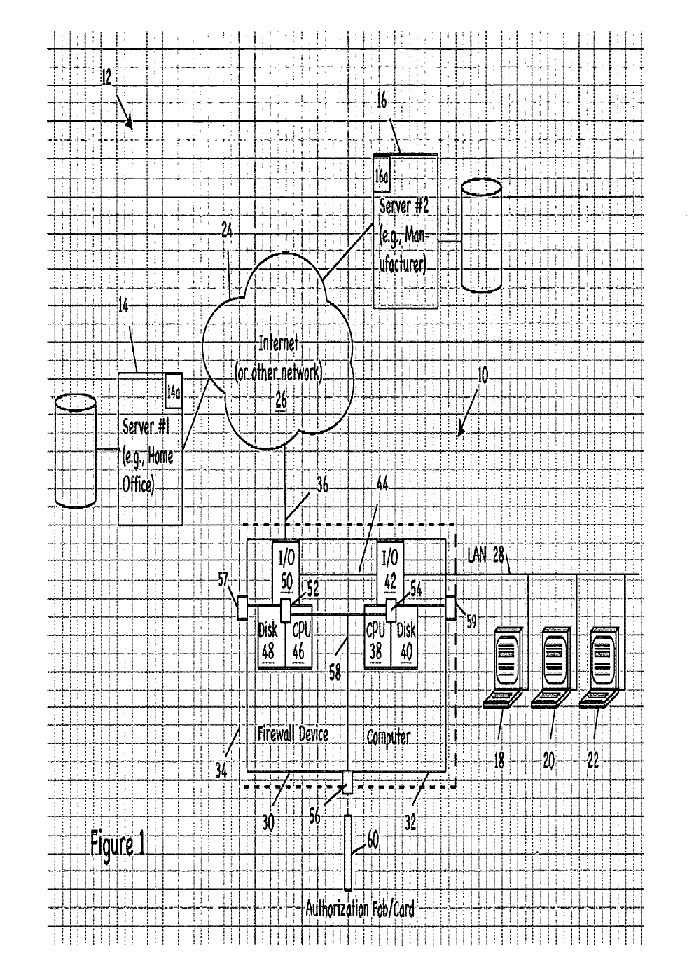

FIG. 1 depicts a digital data processing device 10 and system 12 according to one practice of the invention.

Illustrated digital data processing device 10 is a client workstation or server workstation of the type commonly used in a modern-day business enterprise; however, in other embodiments, the device 10 may be an embedded processor, personal digital assistant (PDA), personal computer, mainframe, or other digital data processing apparatus of the type known in the art capable of executing applications, programs and/or processes. Though not a requirement of the invention, illustrated device 10 is “headless”—that is, it lacks a keyboard, mouse, monitor and/or other peripherals from which an operator would normally monitor, configure and control the appliance Likewise, though not a requirement of the invention, device 10 lacks a diskette or CD drive with which to load operating system, application or other software. The device may include a reader 56, as discussed below.

Coupled to device 10 are digital data processors 14, 16, and 18-22, though one or more of these may not be used in all embodiments of the invention. Digital data processors 14 and 16, one or both of them, by way of non-limiting example, can provide for authentication of device 10, e.g., via respective authentication modules 14a, 16a. In the illustrated embodiment, they are characterized as “servers,” though, they may comprise embedded processors, personal digital assistants (PDAs), personal computers, mainframes, or other digital data apparatus suitable for providing such authentication, e.g., via network 26. Though two such “servers” 14, 16 are shown in the drawing, other embodiments may use a larger or smaller number of such devices.

Digital data processors 18-22 of the illustrated embodiment are workstations, for example, of the type commonly employed by a business enterprise. They utilize services and/or software files, patch files, configuration files, data and/or other files and so forth provided by device 10, e.g., for purposes of operation. Though shown as workstations, in other embodiments, digital data processors 18-22 may comprise any range of digital data devices, e.g., embedded processors, personal digital assistants (PDAs), personal computers, mainframes, or otherwise, suitable for communication coupling with device 10.

With continued reference to FIG. 1, digital data processors 14, 16 are coupled to device 10 via an external IP network 26 such as, here, the Internet—though, in other embodiments, they may be coupled by other network, e.g., public, private, IP-based or otherwise. Likewise, digital data processors 18-20 are coupled to device 10 via a local area network 28—though, again, in other embodiments other networks (e.g., public, private, IP-based, or otherwise), such as WANs, MANs, or otherwise, may be employed.

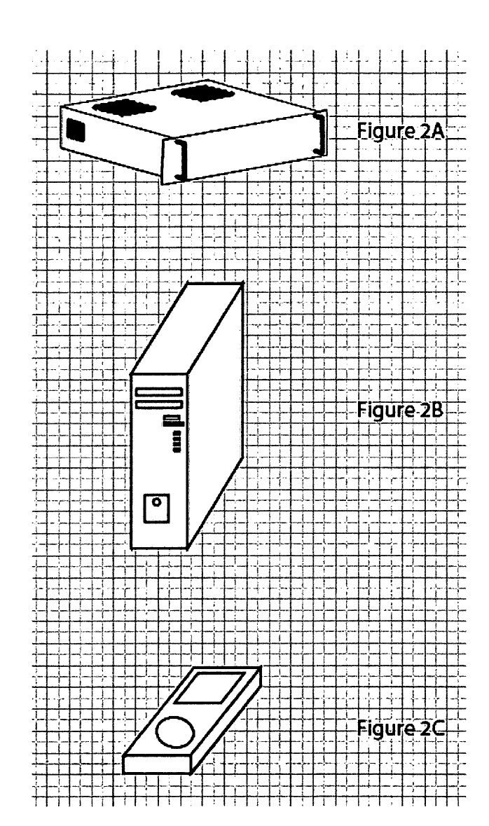

Digital data processing device 10 of the illustrated embodiment includes a firewall device 30 and a computer 32. These share a common path 36 to the Internet or other external network 26, yet, they do not share the same substantive processing logic. Moreover, the devices 30 and 32 of the illustrated embodiment are co-housed within a “common enclosure” 34. As used herein “common enclosure” refers to a chassis, housing and/or other structure (individually or in combination) suitable for containing digital data components for handling and use. By way of illustrative, non-limiting example, devices 30 and 32 can be co-housed within a 1U, 3U or other-sized rack-mount enclosure, e.g., of the type available commercially available in the marketplace. These and other enclosures are shown, by way of example, in FIG. 2. These include a rack-mount enclosure (FIG. 2A), a workstation-tower enclosure (FIG. 2B) and an MP3 (or music player) enclosure (FIG. 2C), all by way of non-limiting example

In preferred embodiments, the enclosure 34 is suitable for containing devices 30 and 32 not only for facilitating their handling and use as a unit but, also, for preventing handling and use of either of the devices without the other. Some such embodiments secure the devices 30 and 32 within the enclosure 34, for example, by way of epoxy or otherwise, so that attempts to physically access either device 30, 32 without the other results in breakage and/or is otherwise frustrated.

Still other embodiments utilize a “virtual” common enclosure. Thus, although in those embodiments, the two devices 30 and 32 are not contained in a physical common enclosure, they are coupled (physically, electronically, optically, or otherwise) such that one cannot be used (though it might be moved) without the other—and, specifically, in some embodiments such that the computer 32 cannot be used without the firewall device 30.

Computer 32 of the illustrated embodiment comprises a CPU 38 and static storage, e.g., by way of non-limiting example, a disk drive 40, static RAM, or the like. It also includes input/output (I/O) section 42 providing peripheral access. In this regard, I/O section 42 includes a network interface card, modem or other interface suitable for communication with firewall device 30 via interconnect 44 and, optionally, thereby, to the Internet or other external network 26. In the illustrated embodiment, that interconnect supports communications via Ethernet protocol, though other embodiments may support communications via other protocols, industry-standard, proprietary or otherwise. Computer 32 is a “general purpose computer” in the illustrated embodiment; however, other embodiments, it may be a special-purpose computer, personal digital assistant, MP3 player, game player, or other digital data processing device.

Firewall device 30 selectively blocks packets traveling between digital data device 10 and network 26, e.g., over path 36 to the Internet or other external network 26. That path 36 comprises a T1 line, T3 line, Ethernet, wireless link, satellite link, or other direct, indirect, modulated or other communications path of the type suitable supporting communications between digital data device 10 and network 26. The firewall is coupled to the path 36 via a network interface card, modem, or other communications mechanism appropriate therefor. The device 30 operates in the conventional manner of firewalls known in the art, as adapted in accord with the teachings hereof, e.g., to restrict connectivity between the computer 32 (and, more generally, device 10) and network 26 absent authentication.

In this regard, as shown in the drawing, computer 32 is coupled to network 26 via interconnect 44, firewall device 30 and pathway 36. Moreover, in the illustrated embodiment the sole digital communications path between the computer 32 and firewall 30 is via interconnect 44, there not being, by way of example, other wiring or functionality in or associated with device 30 support such communications.

The firewall 30 may be of conventional architecture known in the art, e.g., comprising CPU 46, static storage (e.g., disk 48) and an input/output section 50 (e.g., including a network interface card, modem or other adapter supporting communications via interconnect 44 and link 36). Alternatively, or in addition, the firewall may, by way of example, be implemented in specialized packet-processing or other circuitry.

Regardless, in the illustrated embodiment, CPU 46 is separate and distinct from CPU 38. Thus, by way of example, the firewall device 30 does not use the computer's 32 central processing unit (CPU) 38 to execute firewall logic. More generally, one or more (and, preferably, all) of CPU 46, disk 48 and I/O section 50 of firewall 30 are separate and distinct from CPU 38, disk 40 and I/O section 42 of the computer 32. Put another way, devices 30 and 32 preferably do not share each other's respective CPU, storage or I/O. Likewise, the firewall and computer can each have their own respective power supply (not shown).

The firewall device 30 and computer 32 of the illustrated embodiment each include a security module, labeled 52 and 54, respectively, in the drawing. Module 52 is coupled to the CPU 46, disk 48, I/O section 50 and/or other functionality of firewall device 30 to limit (or prevent) operation, modification and/or connectivity of that device 30, e.g., in the absence of physical, electrical, electromagnetic, magnetic, or other coupling of a token (as described below) and/or external authorization from sites 14 and/or 16.

Thus, by way of non-limiting example, absent such coupling and/or authorization, device 30 can be prevented from accessing or permitting access to (or from) selected sites, on at least selected ports, of at least selected packet types, by at least selected applications. Since, in the illustrated embodiment, the device 30 falls on the communications pathway between the computer 32 and the Internet (or other external network) 26, the absence of the aforementioned coupling and/or authorization by device 30, has the effect of likewise preventing computer 32 from accessing (or being accessed from) at least selected sites, on at least selected ports, of at least selected packet types, by at least selected applications.

By way of further non-limiting example, absent the aforementioned coupling and/or authorization, device 30 can be prevented loading at least selected software files, configuration files, patch files, rules files, data and/or other files, (ii) executing at least selected such files, (iii) accessing at least selected peripherals (not shown), and/or (iv) processing at least selected data. This is particularly germane, by way of example, in the illustrated embodiment, wherein firewall 30 is itself implemented using a computer-like architecture, e.g., a CPU, disk and I/O section.

Module 54 is similarly coupled to the CPU 38, disk 40, I/O section 42 and other functionality of computer 32 to limit (or prevent) its operation, modification and/or connectivity in absence of such a token and/or external authorization. Thus, by way of non-limiting example, absent such coupling and/or authorization, computer 32 can be prevented loading at least selected software files, patch files, configuration files, data and/or other files, (ii) executing at least selected software files, configuration files, data files, rules files, patch and/or other files, (iii) accessing to at least selected peripherals (not shown), and/or (iv) processing at least selected data.

Though two separate modules 52, 54 are shown in the drawing, some embodiments use a single module, e.g., serving both firewall 30 and computer 32 or serving only a single one of them, while other embodiments employ still more modules, each serving subsets of CPU, disk, I/O and/or other device functionality of the devices 30, 32. Regardless, such modules can be implemented as hardware and/or software locks, or otherwise, inhibiting operation of the CPU, disk, I/O and/or other functionality to which they are coupled, e.g., in absence of the token and/or external authorization, as discussed further below. With respect to the firewall device 30, module 52 (or its equivalent) can be implemented, by way of non-limiting example, via packet inspection rules that, until released, block all but selected packets types directed to selected addresses by selected application and so forth (e.g., HTTP packets directed to an external authorization site).

The device 10 also includes a reader 56, e.g., on the serial bus 58, that is externally accessible by the operator for entry, keying or other “coupling” of a token. The token can be, by way of example, a smart card, credit card, USB fob, flash card, SD card, memory stick, key, or any other article that signifies its holder as an authorized operator of the device 10 and/or one or more software files patch files, configuration files, rules files, data files and/or other files or components thereof. Preferably, the token uniquely identifies the holder as such, e.g., as is the case with a security key fob token, a credit card, a smart card, a memory card or stick with pre-recorded security code, and so forth; however, this is not a requirement of the invention. Token 60 can be passive or active, e.g., as in the case of a biometric token that scan fingerprints, retinas, and so forth.

The token is preferably of small form factor (e.g., smaller than a 3½″ floppy diskette and, preferably, as small or smaller than a conventional USB “key fob” memory device); however, this is not a requirement of the invention. Hence, a CD, DVD or similar article is used in some embodiments as the token. Preferred tokens are magnetic, electromagnetic, optical, or so forth; however, in some embodiments, metallic “toothed” keys (or their plastic equivalents) are used. Similarly, in some embodiments, the token is a cardboard, paper, plastic, metallic or other card or sheet with a unique security code imprinted on it.

The reader is appropriate to the form factor and type of the expected token 60. Hence, in the case of a smart card, credit card, USB fob, flash card, SD card, memory stick, or the like, the reader comprises a magnetic reader; in the case of a CD, DVD, or the like, it comprises an optical reader; in the case of a toothed key, it comprises an appropriate tumbler or other lock mechanism; in the case of a token with an imprinted security code, it comprises an an optical reader or keypad by which the operator can enter the code; and, so forth. Though illustrated as a separate component of the device 10, it will be appreciated that the reader may be integral with other components of the device (e.g., as in the case, by way of non-limiting example, where a keyboard otherwise provided with the device 10 is also used as a keypad for entry of a code on the token, and/or where a DVD reader otherwise provided for loading of software files, configuration files, data files, rules files, patch files, or otherwise, on the device 10 is also used for reading a DVD token).

Though reader 56 is shown in the drawing coupled to security modules 52, 54 by way of bus 58, it will be appreciated that other mechanisms of coupling the reader to the modules may be utilized, instead or in addition. Moreover, it will be appreciated that though only a single reader 56 is shown in the illustrated embodiment, other embodiments may utilize more readers, e.g., one for each security module. Still further, other embodiments may provide a reader (or readers) for only a single one of the modules 52, 54 and, for example, no reader for the other such module. The utilization of these and other configurations will be evident in the discussion below and elsewhere herein of the operation of device 10.

In addition to reader 56, the firewall device 30 and computer 32 may have one or other ports, interfaces and peripherals (collectively, “ports”) of the type conventionally used in the art. These can include USB ports, firewire ports, serial ports, ethernet ports, wireless network interface cards (802.11, BlueTooth, etc.), memory cards readers, diskette drives, CD drives, DVD drives, and so forth. Ports 57 of device 30 are coupled the CPU 46, disk 48 and/or I/O section 50 of that device in the conventional manner. Likewise, ports 59 of device 59 are coupled the CPU 38, disk 40 and/or I/O section 42 of that device in the conventional manner. As above, in preferred embodiments, devices 30 and 32 do not share common ports, e.g., other than the reader 56, if even that.

In some embodiments, a “virtual” token 60 is used in place of a physical one as described above. In these embodiments, security codes and/or data structures otherwise maintained on such a physical token are, instead, maintained (at least in part) internal to device 10 (e.g., in a hidden memory location on drives 40 and/or 48, a separate store, and so forth).

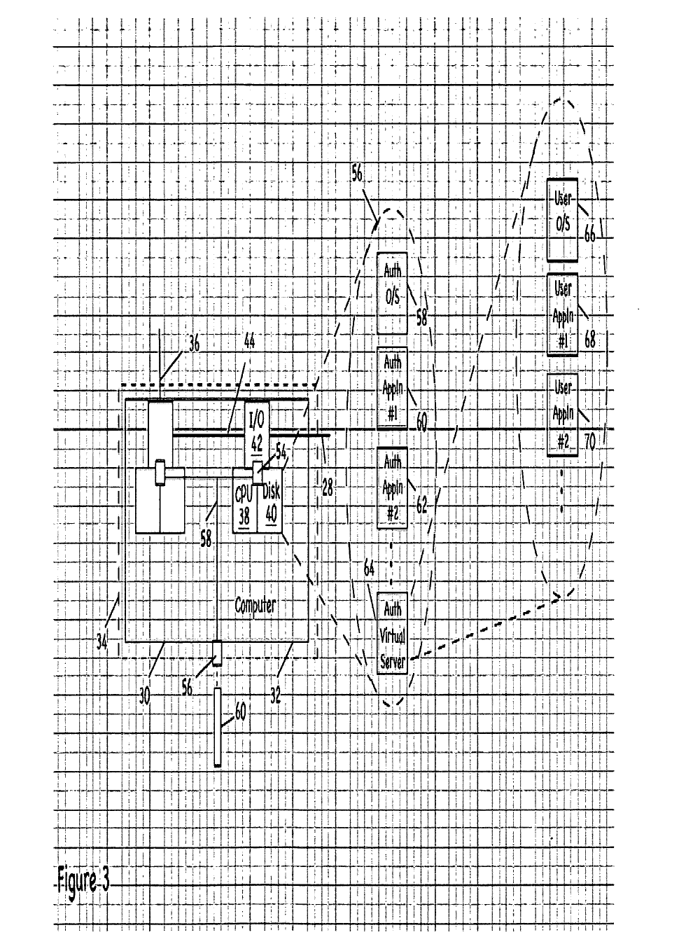

FIG. 3 depicts an installation of software applications on device 10. Specifically, disk 40 includes executable disk image 56 comprising operating system code 58 and applications code 60, 62, as well as attendant configuration, initialization, data and other files, used in normal operation of that operating system and applications code. Operating system code 58 can be, by way of non-limiting example, selected from the Windows™ family of operating systems, Linux, Unix, Mac OS X®, or any other proprietary or non-proprietary operating system suitable for execution on computer 32, adapted for operation in accord with the teachings hereof. Applications code 60, 62 represents any applications code suitable for execution on operating system 58.

Image 56 can, further, include a virtual server application 64, itself, providing a contained environment (with necessary memory spaces, registries, stacks, environmental variables, and so forth) for execution of an operating system 66 and one or more applications 68, 70. Virtual server 64 can be Virtual PC®, VMware®, or any other emulator suitable for execution on computer 32 and under the operating system 58. Applications 68, 70 represent any applications code suitable for execution on operating system 66, under server 64, and so forth.

Operating system 58 and applications 60-64 of the illustrated embodiment are designated as “authorized,” indicating that their installation and use has been authenticated (e.g., via coupling of the token 60 and/or external authorization, as discussed elsewhere herein). On the other hand, operating system 66 and applications 68-70 are not so designated, indicating that although their use may be permitted, it has not necessarily been authenticated in that manner.

Operation

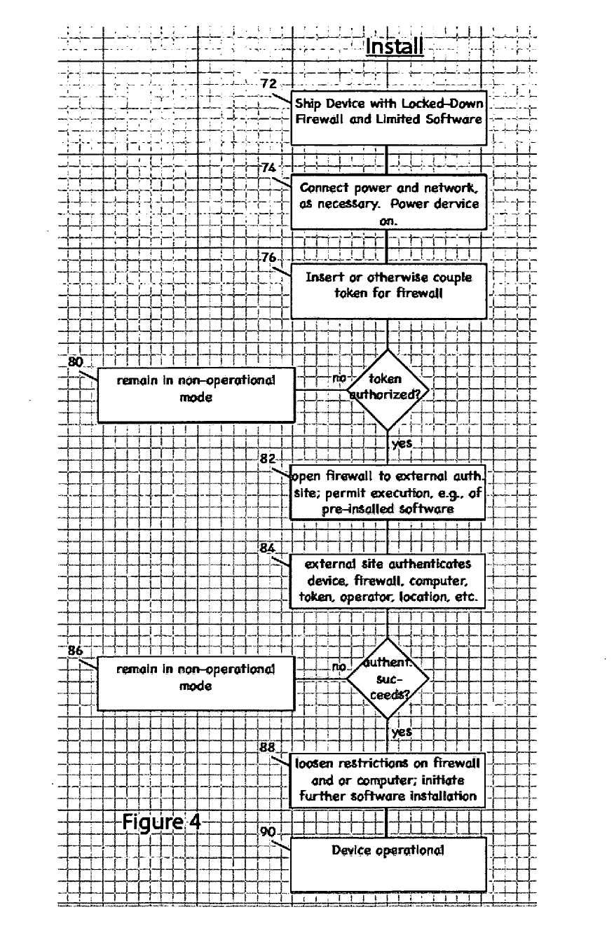

FIG. 4 depicts methods according to the invention for securing device 10 and/or its components (e.g., firewall 30 and computer 32) from unauthorized use or operation. Those skilled in the art will appreciate that these are just examples of the ways in which device 10 can be employed and operated, and that it may be used in other ways as well.

Referring to FIG. 4, in step 72 the device 10 is shipped or otherwise provided to a site with (i) the firewall device 30 “locked down” so as to permit no connectivity over path 36 (to the Internet or other external network 26), (ii) limited installed software files, patch files, configuration files, rules files, data files and/or other files (collectively, “software”) on computer 32, (iii) other than reader 56, no operational ports on firewall 30 or computer 32 through which such software might be installed (prior to authorization). The site may be, by way of non-limiting example, a remote site to which the safety of shipment is unsure (e.g., due to risk of theft) or at which recipient is unverified (e.g., as with a new customer with no credit history).

With respect to point (ii), in some embodiments, the installed software can be limited, by way of example, to that required—if at all—to accept information from the reader 56, to implement security modules 52, 54 and otherwise. In other embodiments, the installed software can represent a “basic” system, having functionality desired by most users, but no special or “high end” features requested, for example, by more discerning users. In still other embodiments, the installed software can represent a “loaded” system with a complete or more complete set of functionality requested or desired by one or more users (e.g., “high end” features).

In step 74, the device 10 is connected to a power source, if necessary, and placed in coupling with path 36. This latter step can entail, for example, plugging in any necessary network cabling (e.g., in the case of wired links), placing the device 10 to ensure that there is adequate signal (e.g., in the case of 802.11 or other wireless links), and so forth. In some embodiments, by way of non-limiting example, this step is carried out by the operator and, in other embodiments, by the courier who delivered the device to the site.

The device 10 can be powered on at this point, although its responsiveness will be limited. Apart, for example, from displaying a message (e.g., on an integral or attached display, not shown) instructing the operator to insert an authorized token, the device will not operate in the expected manner of a general-purpose computer and/or firewall (and, indeed, may not appear to the operator to work at all).

In step 76, the token device 10 is “coupled” with the reader 56. Depending on the token and reader types, this can include inserting the token in the reader, swiping the token past the reader, keying a code on the token into the reader, and so forth. In embodiments employing multiple tokens (and/or readers), each for a respective one of the firewall 30 and computer 32, this step includes coupling to the reader for each device 30, 32 to be activated. In embodiments utilizing a virtual token, “coupling” is attained, for example, via human-to-human, human-to-machine, or machine-to-machine communications, e.g., with an authorization vendor, authorization site 14, 16, or so forth. Where human interaction is involved, codes received by the operator (for example) from an authorization vendor may be typed into reader 56 in order to “couple” the virtual token. When machine interaction is involved, those code can be downloaded, e.g., via “openings” in the firewall 30.

As noted, embodiments of device 10 operating in accord with this example will appear substantially “non-operational” to the operator prior to coupling of token(s) 60. The same is true if the coupled token(s) is not authorized. See step 80.

If the token(s) is authorized, module 52 relaxes locks on firewall 30 at least to a degree sufficient to enable connectivity over path 36 and network 26 to one or more external authorization sites, e.g., servers 14, 16. Likewise, in the illustrated embodiment module 54 relaxes locks on computer 32 at least to a sufficient degree to permit pre-installed, authorized software files, configuration files, data files, rules files, patch files and/or other files to execute and/or to be used. See step 82. In embodiments that do not require authorization for both firewall 30 and computer 32, insertion of the token(s) 60 may be sufficient to enable full operation of one or both of those devices 30, 32, e.g., at least to the extent commensurate with the authorization carried by the token.

In step 84, an authentication module 14a and/or 16a on one or both of the external sites authenticates the digital data processing device 10, the computer 32, any software files, configuration files, data files, rules files, patch files and/or other files thereon, the firewall device 30, and/or the token 60. Such authorization can be performed in a conventional manner known in the art, e.g., by challenging each of those devices for encrypted and/or “hidden” memory location values, and so forth. Where token 60 uniquely identifies the holder (e.g., as is the case with a security key fob token, a credit card, a smart card, a memory card or stick with pre-recorded security code, and so forth), authorization of the token 60 can additionally include establishing link with holder's and bank account or other payment mechanism, e.g., for purposes of verifying credit history, debiting for “activation” of device 10, for installation of software, et cetera.

The authentication module(s) can also authenticate the operator, by challenge or otherwise. The authentication, which can include verifying payment and/or credit history, may involve communications between modules 14a and 16a and/or with other digital data processing apparatus (e.g., credit card validation severs, banking/credit institution servers, and so forth).

Further, the authentication module(s) can authenticate the actual or apparent location of the digital data processing device in the real world, digital world or otherwise, e.g., based on on-board GPS (not shown), IP address routing, user input, and so forth.

If authentication fails, device 10 continues in the appearance of being “non-operational.” See step 86. In some embodiments, the device notifies the operator of the reason for non-authentication—e.g., by displaying a message (e.g., on an integral or attached display, not shown)—and invites correction, e.g., registering, pre-paying, clearing credit history, and so forth.

If authentication succeeds, in step 88, the authentication module(s) 14a and/or 16a can signal the security module(s) 52, 54 to remove or loosen still further restrictions on operating and/or updating the computer 32, including, for example, restrictions on booting the computer, loading or executing software files, configuration files, data files, rules files, patch files, and/or other files, accessing peripherals, and/or processing data. Such signaling can likewise result in removing or loosening restrictions on operating and/or updating the firewall 30, including, for example, restrictions on accessing the Internet (or other external network), addresses thereon, via ports, using selected packet types and/or by applications.

Alternatively, or in addition, in step 88, the authentication module(s) 14a and/or 16a can signal the security module(s) 52, 54 and/or the token to initiate installation of executable disk image 56, of the operating system 58, and/or one or more applications 60-64 thereof. This can be effected, for example, in embodiments which are shipped with software representing less than the complete set of function requested or desired by the user. By way of non-limiting example, the authentication module(s) 14a and/or 16a can signal the security module(s) 52, 54 and/or the token to initiate installation of an executable disk image 56 for, say, an e-mail server (e.g., an “Exchange” server), file server, a corroboration server, and so forth.

In some embodiments, this is accomplished utilizing methods, functionalities and storage structures paralleling those disclosed in copending, commonly assigned U.S. Patent Application Ser. No. 60/659,351, entitled “Methods and Apparatus for Installation/Reinstallation of Executable Disk Images On Digital Data Processors,” filed Mar. 7, 2005, the teachings of which are incorporated herein by reference.

Thus, by way of non-limiting example, token 60 of the instant embodiment can store an executable image like that denoted element 32 in the aforementioned application and drive 40 of the instant embodiment can maintain executable and/or hidden partitions like those denoted 16a, 16b of that application with executable and/or compressed images like those denoted 18, 42 of that application. In embodiments of the present invention having two such tokens 60, one of each device 30, 32, the aforesaid functionality can be provided on each such token and within each such device 32.

Continuing the example, the authentication module(s) 15a and/or 16a of the present embodiment can cooperate with security module(s) 52, 54 to effect one or more of the following actions:
authenticate the token(s) 60 and its (their) use with device 10 and/or components 30, 32 thereof, in a manner paralleling validation of “device 30” in step 48 of the aforesaid application, and/or
permit the operator to monitor and/or control installation of executable disk image 56, of the operating system 58, and/or one or more applications 60-64 thereof, and/or data on the computer 32 (e.g., including selection of image or otherwise for installation) in a manner paralleling the operations described in steps 50-54 of the aforesaid application, and/or
permit the operator to monitor and/or control installation of software files, configuration files, data files, rules files, and/or patch files on the firewall device 30 (e.g., including selection of image or otherwise for installation) in a manner paralleling the operations described in steps 50-54 of the aforesaid application, and/or
authenticate use of the token(s) 60 to decompress the aforesaid executable image, software files, configuration files, data files, rules files, and/or patch files, in a manner paralleling the operations described in step 56 of the aforesaid application, and/or
decompress an executable image, software files, configuration files, data files, rules files, and/or patch files in a manner paralleling the operations described in step 58 of the aforesaid application.

Other embodiments utilize a similar method, yet, download (e.g., from authorization servers 14, 16, or otherwise) software files, configuration files, data files, rules files, patch files, and so forth, that are to be installed on firewall 30 and/or computer 32.

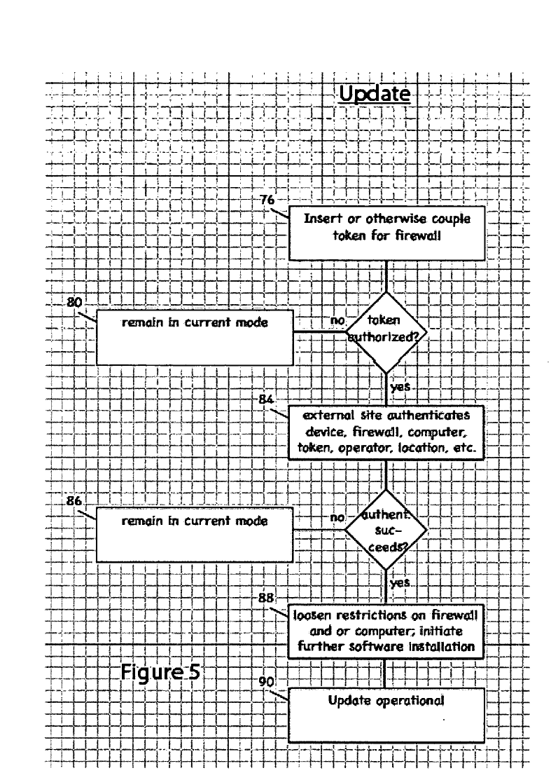

Some embodiments of the invention utilize the methodologies and systems described in copending, commonly assigned U.S. patent application Ser. No. 11/120,133, entitled “Digital Data Processing Methods And Apparatus For Management Of Software Installation And Execution,” Filed May 2, 2005, the teachings of which are incorporated herein by reference, and, particularly, by way of non-limiting example, in steps 21-30 thereof, in order to manage installation of software, activation of software (including drivers), execution of patches in connection, etc., with such configuration alterations (per FIG. 5 hereof), and so forth. This applies, as well, to installation or modification of data files, firewall rules, and so forth.

It will be appreciated that the authorizations in step 88 may be effective as to some functionality on firewall 30 and/or computer 32, but not for other functionality. Thus, for example, where only a basic configuration has been paid for, the authorization may only be effective for releasing restrictions and/or initiating installation on/of software files, configuration files, data files, rules files, patch files, and/or other files, and/or hardware for achieving that level of operation. On the other hand, to continue the example, where a more complete configuration has been paid for, the authorization may only be effective for releasing restrictions and/or initiating installation on/of such files and/or hardware for higher levels of operation. Of course, it will be appreciated that payment may be only one factor employed—if at all—in the illustrated embodiment for determining authorization level, and that other embodiments may employ other factor(s) in addition or all together.

Following step 88, the device 10 and its constituent firewall 30 and computer 32 of the illustrated embodiment is of a software and hardware configuration sufficiently complete to be ready for use in the expected manner. Step 90.

In some embodiments, a similar set of steps to those discussed above—and, particularly, steps 76-80, 84-90—must be executed in order to alter that configuration, e.g., to add additional software files, configuration files, data files, rules files, and/or patch files, and so forth.

Thus, for example, as shown in FIG. 5, in order to alter the configuration by way of adding new software files, configuration files, data files, rules files, patch files, and/or other files, activating pre-installed software, adding new hardware (e.g., requiring opening of additional ports and/or installation/execution of drivers), the operator inserts the token(s) per step 76, which if not validated results in no operational change per step 80. If validated, the external site performs authentication per step 84, e.g., validating that the current configuration and/or requested change is authorized. If not, no change is made, per step 86. Otherwise, further restrictions are loosened and/or the requested additional software is downloaded, decompressed, and/or installed.

In some embodiments, device 10 is rendered totally or partially non-operative, e.g., by the passage of time, re-booting, re-assignment of IP address, or other pre-programmed or operator-selected event. This can be useful, by way of example, where the device is leased or rented and where additional authorizations (and fees) are required for continued use. This can also be useful, by way of further example, to prevent theft. Regardless, a device so rendered totally or partially non-operative may be reactivated via execution of one of more of the steps shown in FIG. or 5.

Methods, apparatus and systems according to the invention can be employed in several advantageous ways. Thus, by way of non-limiting example, a hardware device 10 can be shipped to a customer, for example, in “non-operational” mode. It remain so until an authorized token 60, such as a credit card, etc., is inserted which can result, for example, in one or more of the following actions:
installation (e.g., from a compressed executable image on token and/or a hidden partition on disk 48) of software necessary even from basic operation of the computer 32 and/or
opening communication, via firewall 30, between the computer 32 and sites other than, for example, authorization servers 14, 16, and/or
enabling operator selection of “personality,” e.g., executable image, applications and/or data to be installed on computer 32 and/or firewall 30, and/or
establishing financial relationship between token holder's bank account (or other payment mechanism) and, for example, authorization server 14, 16,
preventing actions modification of device 10 configuration without insertion and re-authorization of token 60.

The foregoing is applicable not only to digital data devices configured as shown in FIG. 1, but also to special-purpose computer, personal digital assistant, MP3 player, game player, or other digital data processing devices. In the case of MP3 players, by way of example, such devices constructed and operated in accord with the invention are delivered at low cost to potential customers. Upon inserting a credit card token 60 into on-board reader 56 and placing the player in communications coupling with a network 16, authorizations and installations as described above are effected such that necessary software files, configuration files, data files, rules files, and/or patch files and desired data files (e.g., music and video) are installed and placed in operation.

The foregoing can be extended, by way of example, in embodiments such as those shown in FIG. 4 in which digital data device 10 is coupled to one or more digital data processors 18-22, e.g., by way of a LAN or other network. In these embodiments, device 10 can serve as store-and-forward site for software files, configuration files, data files, rules files, and/or patch files to be installed on those apparatus 18-22. Thus, for example, upon authorization as discussed above (including, where necessary, payment of additional fees, credit checks, credit charges, and so forth), the authentication module(s) 14a and/or 16a can signal the security module(s) 52, 54 and/or the token(s) 60 to initiate installation of files (e.g., installation files) that can be used to install software files, configuration files, data files, rules files, and/or patch files, and so forth, and, thereby, to add hardware and otherwise alter the configuration of digital data processors 18-22.

Described above are methods, apparatus and systems meeting the desired objects. It will be appreciated that the embodiments described and illustrated here are merely examples of the invention and that other embodiments offering changes thereto fall within the scope of the invention, of which we claim:

In view of the foregoing, what I/We claim is:

1. A digital data processing device, comprising
A. a firewall device and a computer that are housed in common enclosure,
B. a path supporting communications to any of the Internet or other network (collectively, “external network”), the firewall device and the computer being coupled to the path for communications over the external network,
C. the firewall device and the computer being free of common processing logic.

2. The digital processing data device of claim 1, wherein the path comprises any of a modem, network interface card or other communications device supporting access to the external network any of wire, wireless, or optical means, or a combination thereof.

3. The digital data processing device of claim 2, wherein the firewall device and the computer communicate with one another via the path.

4. The digital data processing device of claim 2, wherein the firewall device and the computer communicate over the path using an ethernet protocol.

5. The digital data processing device of claim 2, wherein the computer and the firewall device each comprise a separate respective processing logic.

6. The digital data processing device of claim 5, wherein the processing logic of each of the computer and the firewall is a central processing unit.

7. The digital data processing device of claim 5, wherein the computer and the firewall device each comprise a separate respective storage device.

8. The digital processing data device of claim 5, wherein the computer is any of a general-purpose computer, a special-purpose computer, personal digital assistant, MP3 player, game player, or other digital data processing device.

9. The digital processing data device of claim 5, wherein the computer and the firewall device each comprise a separate respective power supply.

10. The digital processing data device of claim 2 configured to limit any of operation, modification and/or connectivity of the computer absent authentication.

11. The digital processing data device of claim 10, wherein the computer and the firewall device are coupled to the common path such that that access by the computer to the external network is mediated by the firewall device.

12. The digital processing data device of claim 12, comprising a security module that is coupled to the computer and that limits any of operation, modification and/or connectivity thereof absent coupling a token with the digital processing data device.

13. The digital processing data device of claim 12, wherein the token couples with The digital processing data device any of mechanically, electrically, magnetically, optically, or electro-magnetically, or a combination thereof.

14. The digital processing data device of claim 13, wherein the token comprises any of a key fob, smart card, credit card, or the like.

15. A digital data processing device, comprising
A. a firewall device and a computer that are housed in common enclosure,
B. a path supporting communications to any of the Internet or other network (collectively, “external network”), the firewall device and the computer being coupled to the path for communications over the external network such that communications by the computer over the external network are mediated by the firewall device,
C. the path comprising any of a modem, network interface card or other communications device supporting access to the external network via any of wire, wireless, or optical means, or a combination thereof.
D. the firewall device and the computer communicating to one another over the path via an ethernet protocol, the digital processing data device configured to limit any of operation, modification and/or connectivity of the computer absent authentication,
E. a security module that is coupled to the computer and that limits any of operation, modification and/or connectivity thereof absent (i) coupling a token with the digital processing data device, and (ii) external authentication received via the external network.

16. The digital processing data device of claim 15, wherein the token couples with The digital processing data device any of mechanically, electrically, magnetically, optically, or electro-magnetically, or a combination thereof.

17. The digital processing data device of claim 15, comprising a security module that is coupled to the firewall device and that limits any of operation, modification and/or connectivity thereof absent (i) coupling a token with the digital processing data device, and (ii) external authentication received via the external network.

18. The digital processing data device of claim 17, wherein absent authorization the firewall device any of limits by any of address, packet type, application and protocol communications by the computer over the external network.

19. The digital processing data device of claim 15, wherein the computer executes a plurality of operating system instances within a virtual machine environment, where each operating system instance includes an operating system and one or more applications programs, and wherein the instances utilize independent memory spaces, registries, stacks, and environmental variables.

20. The digital processing data device of claim 19, wherein one or more of the operating system instances are pre-configured by the vendor and one or more of the operating system instances are configured by the purchaser.

21. A digital data processing system comprising
A. a first digital data processing device that is coupled with one or more other digital data processing devices via any of a local area network, wide area network, or other network segment (collectively, “network segment”),
B. the first digital data processing device comprising
i. a firewall device and a computer that are housed in common enclosure,
ii. a path supporting communications to any of the Internet or other network (collectively, “external network”), the firewall device and the computer being coupled to the path for communications over the external network such that communications by the computer over the external network are mediated by the firewall device,
iii. the path comprising any of a modem, network interface card or other communications device supporting access to the external network via any of wire, wireless, or optical means, or a combination thereof,
iv. the firewall device and the computer communicating to one another over the path via an ethernet protocol,
v. a security module that is coupled to the computer and that limits any of operation, modification and/or connectivity thereof absent (i) coupling a token with The digital processing data device, and (ii) external authentication received via the external network.

22. The digital data processing system of claim 21, wherein one or more of the other digital data processing devices comprise client workstations.

23. The digital data processing system of claim 22, wherein any of the client workstations comprise desktop and laptop computers.

24. The digital data processing system of claim 22, wherein the digital data processing device is configured as a mail server, file system server, proxy server.

25. The digital data processing system of claim 22, wherein the data processing device is a store-and-forward site for software executed by the other digital data processors on the network segment.

26. A method of operating a digital data processing device, the method comprising
A. providing the digital data processing device as a firewall device and a computer that are housed in common enclosure, yet, that do not share common processing logic or common storage,
B. providing with the digital data processing device a path that supports communications to any of the Internet or other network (collectively, “external network”), and coupling the firewall device and the computer to that path for communications over the external network,
C. using the firewall device to mediate communications by the computer over the external network, such that communications by the computer over the external network are limited absent (i) coupling a token with the digital processing data device, and (ii) external authentication received via the external network.

27. The method of claim 26, comprising conducting communications between the computer and the firewall device solely via the path.

28. The method of claim 26, comprising limiting any of operation and/or modification of the computer absent (i) coupling a token with the digital processing data device, and (ii) external authentication received via the external network.

29. The method of claim 26, further comprising the steps of
D. providing the digital data processing device, initially, with any of limited software and data,
E. coupling the token with the digital data processing device to establish communications over the external network with an authentication system.

30. The method of claim 29, comprising using the authentication system to provide external authentication to the digital data processing system via the external network.

31. The method of claim 30, responding to such external authentication by any of removing or loosening restrictions on operation and/or modification of the computer.
